(19) United States
(12) Patent Application Publication
(10) Pub. No.: US 2006/0283544 A1
(43) Pub. Date: Dec. 21, 2006

(54) Laser welding apparatus and laser welding method

(76) Inventors: Hiroshi Mori, Tokyo (JP); Susumu Fujita, Shimotsuke-shi (JP); Reiko Koshida, Utsunomiya (JP)

Correspondence Address: E I DU PONT DE NEMOURS AND COMPANY;LEGAL PATENT RECORDS CENTER, BARLEY MILL PLAZA 25/1128, 4417 LANCASTER PIKE, WILMINGTON, DE, 19805, US

(21) Appl. No.: 11/367,892

(22) Filed: Mar. 3, 2006

Related U.S. Application Data
(60) Provisional application No. 60/658,245, filed on Mar. 3, 2005.

(51) Int. Cl. B32B 37/00

(52) U.S. Cl. 156/272.8; 156/379.8

(57) ABSTRACT

A laser welding method and apparatus especially suitable for laser welding polymer articles having low light transmissivity at the wavelength used for laser welding. A protective region is provided to the articles being welded that is designed to protect the irradiated surface from degrading during welding.

This application claims the benefit of U.S. Provisional Application No. 60/658,245, filed Mar. 3, 2005.

### FIELD OF THE INVENTION

The present invention relates to a laser welding apparatus and a laser welding method. The present invention particularly relates to a laser welding apparatus and a laser welding method that can be applied to materials having low laser light transmissivity.

### BACKGROUND OF THE INVENTION

It is often desired to produce molded plastic parts that can be mechanically assembled into more complex parts. Traditionally, plastic parts have been assembled by mechanical means such as by gluing, bolting, or screwing them together or using snap-fit connections. These methods suffer from the drawback that they can add complicated additional steps to the assembly process. Snap-fit connections are often not gas-tight and liquid-tight and require complex designs. Newer techniques include vibration, friction, and ultrasonic welding, but these can also require complex part designs and welding apparatuses. Additionally, the friction from these processes can generate dust that can contaminate the inside of the parts. This is a particular problem when sensitive electrical or electronic components are involved.

A more recently developed technique is laser welding. This method may be used to join two polymeric objects (also referred to herein as members or articles) having different levels of light transmission at the wavelength of the laser that is used for the welding. One object is at least partially transparent to the wavelength of the laser light, while the second object absorbs a significant portion of the incident radiation. The articles are brought into contact and a laser beam is directed at the surface of the partially transparent object such that it passes at least in part through the object and irradiates the surface of the second object, causing the polymer at the surface of the second object to melt, and hence forming a bond between the two objects at the point at which they are in contact and irradiated by the laser beam.

For example, JP published patent applications No. 60-214931 and No. 62-142092 disclose techniques for joining together different synthetic resins where one is relatively transparent to laser light by directing laser light to the side of the relatively transparent synthetic resin.

JP published patent application No. 2001-71384 discloses a method for laser welding resin members wherein a first resin member that does not absorb laser light at the wavelength used and a second resin member capable of absorbing laser light at the wavelength used are brought into contact with each other, and the resulting assembly is irradiated from the side of the first resin member with laser light to weld the members together. This method is characterized in that the first resin member comprises a first resin having dispersed within it a colored material that does not absorb laser light at the wavelength used, and the second resin member comprises a second resin having dispersed within it a colored a material that absorbs laser light at the wavelength used. This method may be used to prepare welded articles in which both members that are welded together have the same color. Similar approaches are described in JP published patent application No. 2000-309694, WO 01/044357, and JP published patent application No. 2003-517075. However, the addition of colorants and other additives may adversely affect the mechanical properties of the resin. The resulting materials may have inadequate strength, insufficient durability, and/or the like.

Furthermore, JP published patent application No. 2001-105499 discloses a technique wherein a resin member that transmits laser light at the wavelength used and that serves as a heat source, and a resin member that does not transmit laser light at the wavelength used are brought into contact, and the bonding surface formed at the point of contact between the transmissive and non-transmissive resin members is heated and melted by irradiation with laser light directed at the side of the transmissive resin member to integrally bond the two members together. This method is characterized in that laser light with a wavelength at which the transmissivity of the transmissive resin member is 26% or greater is used as the heat source during bonding. This reference discloses that this characteristic allows the energy loss of the laser light transmitted by the transmissive resin member to be reduced, sufficient heating and melting to occur at the bonding surface, and adequate welding strength to be ensured.

JP published patent application No. 53-134881 discloses a technique wherein polymeric articles to be laser welded are preheated to a temperature less than or equal to the melting temperature of polymer prior to laser welding.

In the laser welding methods as described above, the partially transparent article must transmit at least above about 25 percent of light at the wavelength used for laser welding. This limits the range of materials that can be used for this process.

However, if laser welding were possible using for the partially transparent article materials that had poor transmissivity (such as below 25%) of light at the wavelength used for welding, then a broader range of materials could be used to form articles for use in laser welding. For example, laser welding would have more automotive applications if it could be applied to less transmissive materials.

Therefore, it is desirable is to provide an apparatus and method whereby materials with low laser light transmissivity can be laser welded without the addition of additives or the like to the material.

### SUMMARY OF THE INVENTION

Briefly stated, and in accordance with one aspect of the present invention, there is provided a laser welding apparatus wherein a first member comprising a thermoplastic polymer and a second member comprising a thermoplastic polymer are brought into contact with each other, and the first and second members are welded together by irradiation of a surface of the first member with laser light, such that the laser light passes through the first member and contacts the second member, and wherein the second member is capable of absorbing the laser light at the point at which the laser light contacts the second member, said laser welding apparatus characterized in that it comprises: laser light irradiation means; fixing means for holding or fixing in place the first and second members; and means for forming a protective region on the first member.

Pursuant to another aspect of the present invention, there is provided a method of laser welding two members, wherein a first member comprising a thermoplastic polymer is brought into contact with a second member comprising a thermoplastic polymer and the first and second members are welded together by irradiation of a surface of the first member with laser light, such that the laser light passes through the first member and contacts the second member, and wherein the second member is capable of absorbing the laser light at the point at which the laser light contacts the second member, and wherein a protective region is formed on the first member while the surface of the first member is irradiated by the laser light.

### BRIEF DESCRIPTION OF THE DRAWINGS

The invention will be more fully understood from the following detailed description, taken in connection with the accompanying drawings, in which:

FIG. 1 is a schematic view showing a conventional laser welding method; (a) is a diagram illustrating the laser welding conditions; and (b) is a diagram showing the portion of the resin heated by irradiation with laser light.

FIG. 2 is a schematic view demonstrating the problems with a conventional laser welding method; (a) is a diagram illustrating the laser welding conditions; and (b) is a diagram showing a portion of the resin heated by irradiation with laser light.

FIG. 3 is a block diagram showing the laser welding apparatus of the present invention.

FIG. 4 is a schematic view showing the laser welding apparatus of the first embodiment of the present invention; (a) is a diagram showing the apparatus configuration; (b) is a diagram showing a laser irradiator; (c) and (d) are diagrams showing protective region formation means.

FIG. 5 is a partial schematic view illustrating the laser welding method of the first embodiment of the present invention; (a) is a view from above; (b) is a cross-sectional view.

FIG. 6 is a partial schematic view illustrating the laser welding apparatus and laser welding method of the second embodiment of the present invention; (a) is a view from above; (b) is a cross-sectional view; (c) and (d) are diagrams showing a specific example of the protection means.

FIG. 7 is a partial schematic view for describing the laser welding apparatus and laser welding method of the third embodiment of the present invention; (a) is a view from above; (b) is a cross-sectional view.

FIG. 8 is a partial schematic view for describing the laser welding apparatus and laser welding method of the fourth embodiment of the present invention; (a) is a view from above; (b) is a cross-sectional view.

FIG. 9 is a diagram showing the resin member used for welding in the examples of the present invention.

FIG. 10 is a diagram showing the laser welding procedure used in the examples of the present invention.

While the present invention will be described in connection with a preferred embodiment thereof, it will be understood that it is not intended to limit the invention to that embodiment. On the contrary, it is intended to cover all alternatives, modifications, and equivalents as may be included within the spirit and scope of the invention as defined by the appended claims.

### DETAILED DESCRIPTION OF THE INVENTION

As used herein, the term “laser light transmissivity” refers to be percentage of incident light having a wavelength to be used for laser welding that is transmitted by an article. When it is stated that an article or member has a specific laser light transmissivity, it is meant that this is the percentage of incident light having the wavelength to be used for laser welding that is transmitted by the article or member at the thickness of the article or member at the region of the article or member at which it is to be laser welded.

As used herein, the term “capable of absorbing laser light” means that an article absorbs sufficient incident light at a wavelength to be used for laser welding to melt the article at the point at which the laser light impinges its surface.

The present invention relates to a laser welding apparatus. This apparatus is a laser welding apparatus wherein a first member whose laser light transmissivity is preferably about 25% or less, and a second member capable of absorbing laser light are brought into contact with each other to form a junction and the first and second members are welded together by irradiation of the junction with laser light, wherein the apparatus has a laser light source, a fixing means for holding or fixing in place the first and second members, and a means for forming a protective region on or near the surface of the first member.

The present invention further relates to a laser welding method. In this method, a first member whose laser light transmissivity is 25% or less, and a second member capable of absorbing laser light are brought into contact with each other to form a junction and the first and second members are welded together by irradiation of the junction with laser light, wherein irradiation with laser light is carried out while a protective region is formed on or near the surface of the first member. The protective region may be created by the use of a means for cooling the surface of the first member that is exposed to laser light; a means for removing volatile substances produced on the surface of the first member that is exposed to laser light; or a means for blocking combustion-aiding substances from the portion of surface of the first member that is exposed to laser light or in the vicinity of the portion that is exposed to laser light.

Not only do the apparatus and method of the present invention make it possible to weld materials having low laser light transmissivity for which laser welding has so far been difficult to accomplish, but it can also be applied to the welding of materials conventionally used for laser welding.

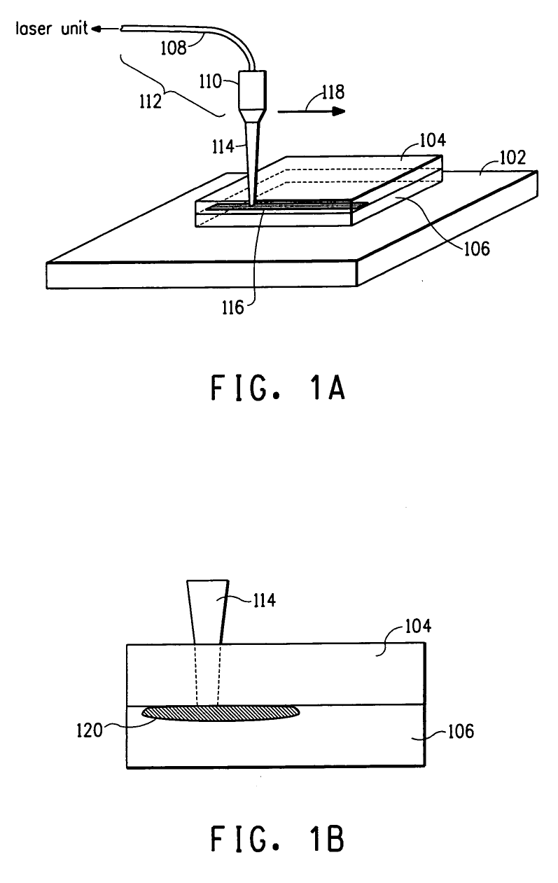

The laser welding method can be generally described with reference to FIG. 1. FIG. 1(a) shows an overview of a method for the laser welding of a plurality of members, FIG. 1(b) is a diagram showing the region in which the members are heated during laser welding. In each of the diagrams referred to in the present application, the same members are denoted by the same reference symbols. The members used in the welding apparatus and process preferably comprise thermoplastic resins.

The laser welding method may be performed using a laser welding apparatus comprising a base 102 such as that shown in FIG. 1(a), laser irradiation apparatus 112 (which may comprise a laser, an optical fiber 108, a laser irradiator 110, and the like), fixing means (not shown) for fixing in place a first resin member and a second resin member, a control unit for controlling the operation of the laser irradiator, and the like. The laser power and scanning speed of the laser may be controlled by the laser irradiation apparatus. When using such an apparatus, the first member 104 and the second member 106 are brought into contact with each other and fixed to the top of the base 102; the first member is irradiated with laser light 114 by transmitting light from the laser to the surface of the first member 104 from the laser unit (not shown) by laser irradiation means 112, which may comprise optical fiber 108 and the laser irradiator 110. During irradiation, the laser light is moved across the surface of the first member 104, for example as shown by arrow 118. If the first resin material has sufficient laser light transmissivity, the laser light passes through the first resin material, reaches the surface of the second member, which comprises a resin material that is chosen to be capable of absorbing laser light, and is absorbed by the second resin material. As shown in FIG. 1(b). The surface region 120 melts and the first resin material and second resin material, which are kept in contact with each other on the base, are welded together at junction 116 as shown in FIG. 1(a).

When an article comprising a polymeric resin is irradiated with laser light, some or all of the light may be scattered or absorbed by a component of the resin, including the polymer matrix or additives that may be present. This reduces the laser light transmissivity of the article. It has been discovered that when such materials having low laser light transmissivity are used for laser welding (such as one that has a transmissivity of less than 25% at the thickness of the portion of the article that is be welded), problems may be encountered in that swelling/blistering, melting, ignition, combustion, and other such defects may occur on the surface of the first resin material at the point at which the surface is irradiated with laser light, and as a result, often a product of high quality cannot be manufactured. The present invention relates to a laser welding apparatus and a laser welding method whereby it is possible to weld materials with low laser light transmissivity without experiencing these concomitant problems.

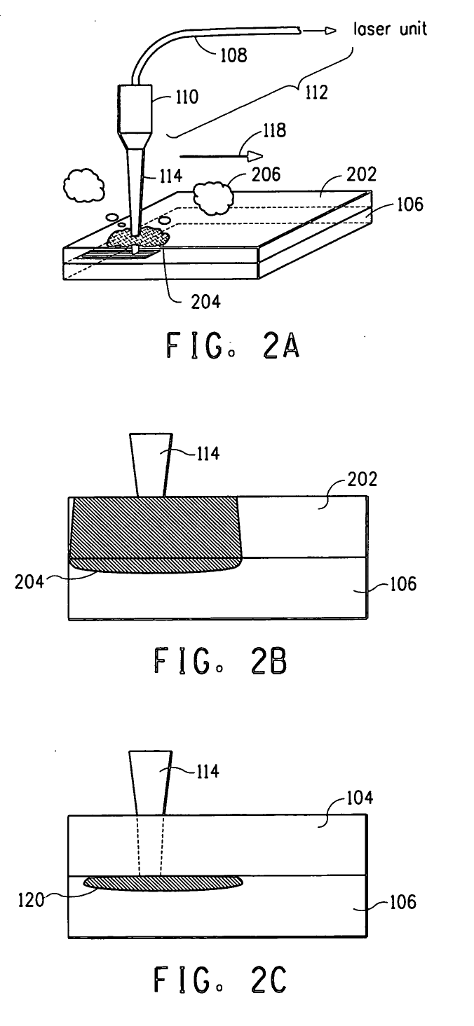

A possible origin of these problems mentioned above is illustrated with reference to FIG. 2 and FIG. 1(b). FIG. 2(a) shows the manner in which laser welding is conducted when a member 202 comprising a resin material with low laser light transmissivity is used as a first member. FIG. 2(b) is a diagram showing the manner in which member 202 is heated during laser welding, and FIG. 1(b) described above. In FIG. 2(a), a conventional laser welding apparatus having the same configuration as the one described in FIG. 1(a) is used, except that the member 202 comprises a resin material having low laser light transmissivity. In this case, the impinging laser light 114 is absorbed by the first resin material 202 before reaching the junction of members 202 and 106. The temperature increases in 204, the portion of article 202 extending from its surface to member 106. When the temperature increase is too great, volatile materials 206 may be emitted.

It is believed that overheating of the resin material comprising the first member can (I) cause volatile gases 206 (FIG. 2(a)) to be emitted from the first member and (II) cause the resin material comprising the first member to melt, particularly at points on the surface at which it is irradiated. As a result, it is believed that (i) the resin material comprising the first member can swell, particularly at points on the surface at which it is irradiated, which can cause blisters to appear on the surface; (ii) the resin material comprising the first member can melt, particularly at points on the surface at which it is irradiated; (iii) when volatile substances having a low ignition point are produced, they can ignite as a result of the high temperatures of the first member; and (iv) the members being welded can ignite as a result of the high temperatures reached, causing the resin material to burn.

Generally, in order to avoid these types of problems, it is often necessary to use a resin material for the first member that has a laser light transmissivity of at least about 25%. The existence of these problems can make laser welding difficult, if not impossible, for resins having a laser light transmissivity of less than about 25%. Though in some cases an additive may be used to increase the laser light transmissivity of a resin, the use of such additives may adversely affect the physical properties of the resin material and the resulting welded article may have inadequate strength, insufficient durability, or the like. The apparatus and method of the present invention do not require the use of a first member comprising such additives.

In one embodiment of the present invention, the first member welded in the present invention comprises a material, preferably a thermoplastic resin, and has a laser light transmissivity of 25% or less, or preferably 12 to 25%, at the wavelength of the laser light used for welding at the point or region of the member at which it is to be laser welded. Examples of suitable materials include crystalline thermoplastic polyesters such as crystalline poly(ethylene terephthalate), poly(butylene terephthalate), poly(propylene terephthalate), liquid crystalline polyesters, polyphenylene sulfide, polyamides (particularly in the case of thick articles) and other such resin materials. These materials may also contain additives such as flame retardants, mineral fillers, and reinforcing agents such as glass fibers. Suitable materials also include those such as polystyrene, polyethylene, polypropylene, polycarbonate, and other such materials whose laser light transmissivity has been reduced to 25% or less by adding additives such as flame retardants, glass fibers, inorganic fillers, and the like.

The present invention can also be used with materials whose laser light transmissivity is greater than 25%, but the invention is particularly beneficial for materials whose transmissivity falls within the range specified.

A material capable of absorbing the laser light used in conventional laser welding can be used for the second member of the present invention. Specific examples include crystalline or amorphous resins such as poly(ethylene terephthalate), poly(butylene terephthalate), poly(propylene terephthalate), polyamides, thermoplastic polyolefins (such as polyethylene, polypropylene, and other such materials), polystyrenes, polycarbonates, and the like. The resins may contain a substance that absorbs light at the wavelength used for laser welding such as carbon black, nigrosine, other infrared absorbing material, and the like. The second member may also be coated with a substance that absorbs light at the wavelength used for laser welding at the surface at which the second member is to be joined to the first member by laser welding. Such coatings may include carbon black, nigrosine, or other infrared absorbing material, and the like.

In the present invention, the thickness of the first member and second member is not particularly limited as long as they can be laser welded, but the thickness of the irradiated portion of the first member is preferably about 10 mm or less, and or more preferably about 0.5 to 4 mm.

In the present specification, the term “protective region” refers to a region that is designed to protect the irradiated surface of the first member from overheating or the negative consequences of overheating described above. In the present invention, the terms “protection means” and “protective region formation means” refer to means for forming the protective region.

In the present invention, the protection means or protective region formation means may be applied directly to the protective region or indirectly to a region separate from the protective region, such that the protective region is formed in the desired location. In the latter case, the protection means or protective region formation means work remotely to form the protective region in the desired location.

Examples of suitable protection means or protective region formation means include:
(A) A means for cooling the portion of the first member that is irradiated with laser light and its vicinity.
(B) A means for removing volatile substances formed on the portion of surface the first member that is irradiated with laser light and its vicinity.
(C) A means for effectively blocking contact of volatile substances or the portion of the surface of the first member that is irradiated with laser light and its vicinity from substances (such as oxygen) that aid combustion.

Examples of the means (A) include (a) injection means for injecting air, nitrogen, helium, or another such gas at a temperature of 0 to 50° C., or preferably 10 to 40° C., onto the portion of the surface of the first member that is irradiated by laser light or other region that rises in temperature during irradiation, (b) covering and cooling means for covering the portion of the surface of the first member that is irradiated with laser light with a member that transmits laser light and is capable of cooling the member (where such covering and cooling means can include a glass or polymeric (such as poly(methyl methacrylate)) cover that can be externally cooled), and (c) heat dissipation means for joining a highly thermally conductive member to the first member at a point other than that that is irradiated by laser light and dissipating excess heat via the highly conductive member (the highly thermally conductive member can also be cooled as necessary).

An example of the means (B) includes (d) injection means for injecting air, nitrogen, helium, argon or another such gas into the portion irradiated by laser light or into the vicinity thereof to remove volatile substances.

An example of the means (C) includes (e) combustion prevention means wherein the portion of the surface of the first member irradiated by laser light or the vicinity thereof is covered with glass, acrylic, or another such laser transmitting member, or with a gas that does not aid combustion, such as argon, nitrogen, helium, or the like. By this means, combustion-aiding substances such as oxygen are prevented from coming into contact with volatile substances, and combustion of volatile substances is prevented.

The protective region may be formed from two or more of the means described above.

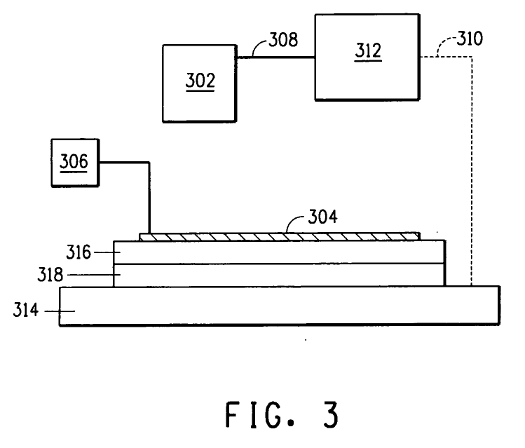

The laser welding apparatus and laser welding method of the present invention will now be described in more detail with reference to FIGS. 3 through 7.

FIG. 3 is a schematic block diagram showing the laser welding apparatus of the present invention. The laser welding apparatus of the present invention has laser light irradiation means 302, a first member 316, a second member 318, a base 314 that includes fixing means for holding or fixing in place the first and second members, means 306 for forming a protective region 304, and control means 312 for controlling the laser light irradiation apparatus 302 or the base 314 so as to perform welding as shown in FIG. 1 where lines 308 and/or 310 are cables that serve to connect elements of the laser welding apparatus. By control means is meant an apparatus that moves the laser light source relative to the first and second members or the first and second members relative to the laser light source during the welding process. The control means may be used to control the scanning speed, that is the speed at which the laser light and first and second members move relative to each other.

With continued reference to FIG. 3, the laser light irradiation means 302 comprises a laser light source, a laser irradiator for irradiating the members to be welded, and an optical fiber for connecting the laser light source with the laser irradiator. These structural elements may be integrated. Examples of the laser light sources that can be used in the present invention include YAG lasers (operating at 1064 nm) and diode lasers (including those having a wavelength in a near-infrared region of 808 nm, 940 nm, or 980 nm), or the like.

The protective region formation means 306 (FIG. 3) makes it possible to provide one or more of the protection means (A) through (C). An example of the injection means (a) or (d) is a device having a function for injecting a specific gas by a blower or the like. An example of the covering and cooling means (b) is a laser light transmitting sheet, plate, or the like that is capable of being cooled. An example of the heat dissipation means (c) is a plate made of steel or another highly thermally conductive material having an opening corresponding to the desired laser light irradiation path on the surface of the first member. An example of the combustion prevention means (e) is a laser light transmitting sheet, plate, or other device made of glass, acrylic, or other material that is sufficiently transparent to the laser light used, or a device for injecting inert gases.

The base 314 (FIG. 3) has a means for fixing the welded portion of the first and second members while keeping these members in contact with each other, and means for fixing the protective region formation means (or a part thereof) as necessary. The fixing means may be designed to fix the first member, the second member, and the protective region formation means (or a part thereof) with a single fixing means, depending on the type of protective region formation means. Alternatively, the protective region formation means may be held in place using a separate device.

The base 314 is not particularly limited as long as it has the fixing means described above. Base 314 can be a fixing base, an XYZ stage, and the like. By the term “fixing base” as used herein is mean a base that does not move relative to the rest of the apparatus. When the base is an XYZ stage, it can also function as the control means described below. The fixing means for holding the first and second members in place may be a clamp or air pressure.

The control means 312 may be used to move the laser light irradiation apparatus 302 and/or the base 314 along the welding path. The control means may also be used to set and control the parameters for welding. The control means may comprise an industrial robot, an XYZ stage (which may also function as a base), a base with a rotatable surface on which the first and second members may be placed (the rotatable surface may also function as the base). A computer may be used to control the control means.

The laser welding method of the present invention uses these devices to perform welding by directing laser light to the surface of the first member 316 while the first and second members are kept in fixed contact and the protective region 304 is formed.

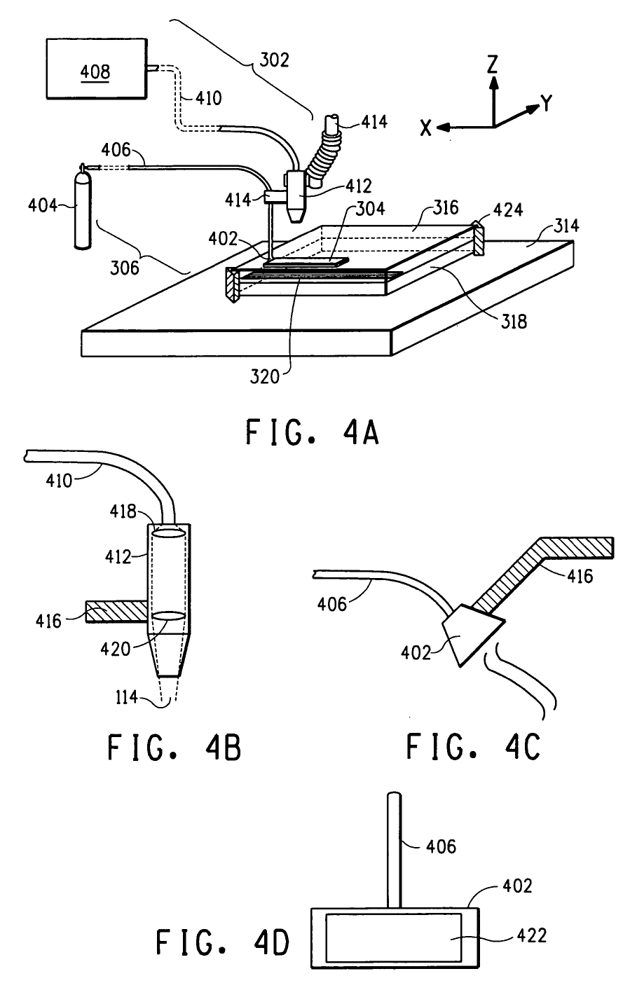

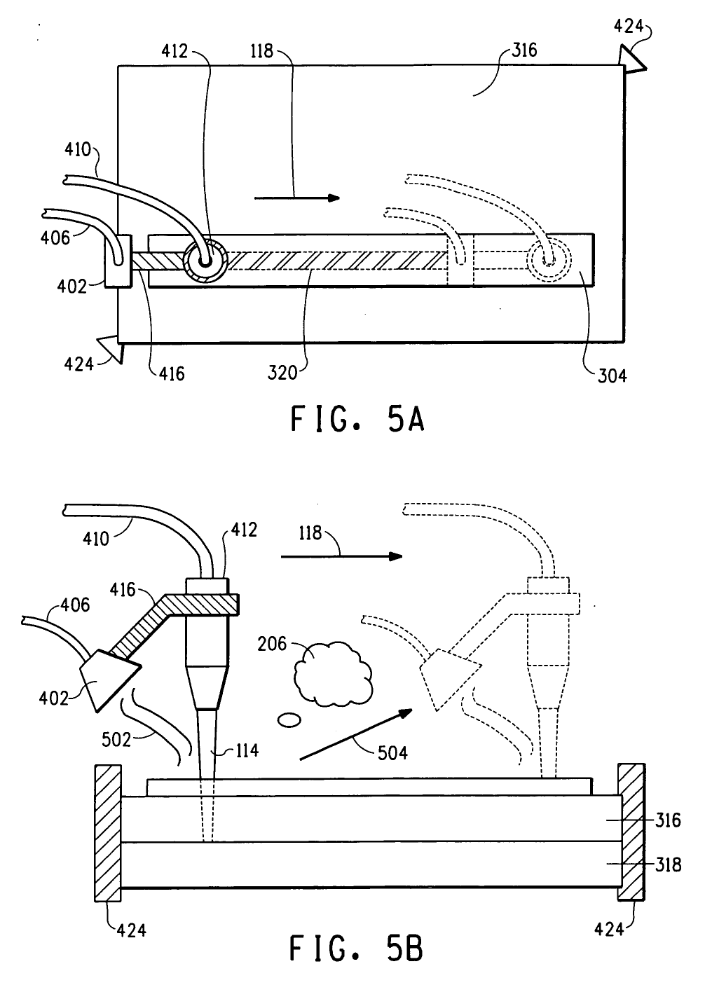

A first embodiment of the present invention will be described with reference to FIGS. 4 and 5. This embodiment uses protective means (a) and/or (d) described above, wherein the protective region is provided by injecting air, nitrogen, helium, or another such gas preferably at a temperature of about 0 to about 50° C. or more preferably, about 10° C. to about 40° C. into the portion of the apparatus, near the portion of the first member that is irradiated by laser light or its vicinity.

FIG. 4(a) is a schematic view of a laser welding apparatus that can be used in the present embodiment, FIG. 4(b) shows schematic views of the laser irradiator, and FIGS. 4(c) and (d) are partial schematic views of the protective region formation means 306. FIGS. 5(a) and (b) are diagrams for describing the laser welding method performed according to the present invention while the protective region is formed.

The laser welding apparatus of the present embodiment has laser light irradiation means 302, protective region formation means 306 for forming the protective region 304, an arm 414 for scanning the laser light irradiation means, and a base 314 having fixing means (for holding or fixing the welded portion) 424, as shown in FIG. 4(a).

The laser light irradiation means 302 has, for example, a laser light source 408, a laser irradiator 412 for irradiating the welded portion with laser light, and an optical fiber 410 for connecting the laser light source and the laser irradiator. FIG. 4(a) shows the laser light irradiation means 302 composed of a plurality of structural elements, and these elements may be integrated with the laser irradiator 412.

As shown in FIG. 4(b) the laser irradiator 412 has a first lens 418 for converting the laser light guided by the optical fiber 410 into a parallel luminous flux, and a second lens 420 for focusing the laser light. The focused laser light 114 is emitted from the laser irradiator 412 and is directed to the surface of the first member. The present embodiment also preferably has a holder 416 for holding a gas ejector 402 (FIG. 4(c)) of the protective region formation means 306, to be described hereinbelow. When using a laser irradiator having this holder, it is possible to move the protective region over the surface of the first member as the laser light is moved, making it possible to form the protective region at an appropriate position near the surface of the first member as long as the gas ejector is located near the laser irradiator. The holder 416 (FIG. 4(c)) is preferably adjustable such that the set position and angle can be varied so that the gas ejector 402 (FIG. 4(c)) described below can be placed at the desired position in accordance with the position of the emitted laser light. For example, the holder may comprise a sliding or telescoping member having a fixing tool or another such mechanism capable of varying the angle of the gas ejector, or a mechanism whereby the gas ejector can be rotated around the periphery of the laser irradiator.

Referring again to FIG. 4(a), in the present embodiment, the protective region formation means 306 has a gas ejector 402, a gas supply part 404 which may be a cylinder filled with the desired gas, and a delivery line 406 for delivering the gas to the gas ejector.

The gas ejector 402 is connected to a gas ejector holder 416 and a delivery line 406, and is designed so that gas can be ejected from a rectangular ejection port 422, as shown in FIGS. 4(c) and (d). The gas ejector 402 in FIGS. 4(c) and (d) is shown by way of example, and the shape of the ejection part and ejection port can take on many forms such as rectangles, circles, or other shapes. The shape can be selected according to the type of protective region to be formed, and the selection can be made with ease by those skilled in the art. Also, the gas ejection port 422 may be formed separately from the delivery line 406 and connected to one end of the delivery line, or one end of the delivery line 406 may be fashioned directly into the gas ejector 402 or the ejection port 422.

The protective region formation means of the present embodiment is a means (a) and/or (d) as described above for diffusing the heat generated by laser light irradiation, or for removing volatile substances, and the gas used is not particularly limited as long as these objects can be achieved. It is possible, for example, to use air, nitrogen, argon, helium, or another such inert gas controlled as necessary in terms of temperature, which is preferably 0° C. to about 50° C. or more preferably about 10° C. to about 40° C. Since gas is ejected in the present embodiment, the configuration of the protective region 304 is arbitrary. For example, the protective region may have a layered configuration such as is shown in FIG. 4(a), or may have a configuration of indeterminate form. A protective region comprising gas may be formed into a layered configuration by forcing the gas through a wide and narrow orifice in a direction parallel to the surface of the first member. The protective region may also have an indeterminate form.

The arm 414 may be moved to scan the laser irradiator. An industrial robot or another such movable part, such as an arm, for example, may be used to move the laser irradiator and the laser irradiator may be held or fixed by the holding or fixing means of the movable part. A holder or similar device can be used as the holding or fixing means as long as the laser irradiator can be detachably held or fixed in place. The device used to move the laser irradiator (specifically, the arm of an industrial robot or the like, for example) is programmed so that scanning is appropriately performed along the path in which welding is performed by the control means 312 (shown in FIG. 3) (a scanning program may be created by programming a computer, or by teaching (instructing) a learning robot).

In the laser welding apparatus of the present embodiment, the laser irradiator 412 may be scanned or the laser irradiator may also be fixed in place and the first and second members moved relative to the laser irradiation by using an XYZ stage or a movable base. In this case, the base is programmed and controlled so that scanning is appropriately performed by for example, a computer program or a learning robot that has been appropriately instructed.

The base 314 has means for fixing and holding the first and second members while keeping portions of their surfaces in contact with each other. The base is not particularly limited as long as it has fixing means, but possible examples include a fixing base, an XYZ stage, or the like. Other possible examples of the fixing means include a device for applying pressure to the junction between the first and second members with a clamp or air pressure, or other such conventional fixing means. The fixing means may be provided at any location as long as the first and second members can be held or fixed in place. For example, when the rectangular portion is to be held or fixed in place as shown in FIG. 4(a), the corners of the first and second members diametrically opposite each other may be held, or the four corners of the first and second members may be held or fixed in place. Otherwise, several sides of the first and second members or two opposing sides may be held or fixed in place.

Reference is now made to FIGS. 5(a) and (b) to describe an embodiment of the laser welding method of the present invention. FIG. 5(a) is a view of the welding apparatus as seen from above, and FIG. 5(b) is a view of the welding apparatus as seen from the side. For the sake of simplicity, FIGS. 5(a)&(b) show only the laser irradiator 412, the optical fiber 410, the gas ejector 402, the delivery line 406 for delivering gas to the gas ejector, the first member 316, the second member 318, the fixing means 424 for fixing in place the first and second members, the protective region 304, the moving direction 118 of the laser irradiator 412, laser light 114, and the welded portion 320.

Reference is now made to FIG. 5(b) which discloses an embodiment of the present invention in which the first member 316 and second member 318 to be welded are fixed in place at the desired location on the base 314 (shown in FIG. 3) by an appropriate fixing means 424 (for example, device for applying pressure to the junction between the first and second members and fixing the first and second members in place with a clamp or air pressure). The laser irradiator 412, wherein the gas ejector 402 is held by the holder 416, is placed at the starting point for the welding operation. The irradiator is positioned using the arm of an industrial robot (control means 312, shown in FIG. 3), which is provided with information about the scanning path and the like.

Continuing reference to FIG. 5(b), a specific amount of air, inert gas, or other such gas is ejected from the gas ejector 402 via the delivery line 406 of the protective region formation means 306 (shown in FIG. 4) The amount of gas ejected is preferably between about 0.02 m/sec and about 10.0 m/sec, or more preferably between about 0.02 m/sec and about 6.0 m/sec. While the gas is being ejected, the laser irradiator 412 is scanned along the surface of the first member (following the direction of arrow 118, for example) by the arm of the industrial robot (not shown) or other method known to those skilled in the art. The scanning speed varies depending on the material to be welded, but, for example, a scanning speed of between about 60 and about 600 cm/min can be used with a polyester resin such as poly(butylene terephthalate) (PBT). Useful laser output also varies depending on the welded material, but, for example, an output of between about 15 and about 150 W can be used with a polyester resin such as poly(butylene terephthalate) (PBT).

The protective region 304 is formed by the ejection of gas 502 from the gas ejector 402, and the portion of the first member 316 heated by laser light is cooled and/or volatile substances 206 are removed (e.g. scattered in the direction of the arrow 504 in FIG. 5(b)). The protective region is preferably formed during irradiation with laser light in order to ensure the functions of the protective region in the present embodiment.

Linear welding was described in FIG. 5(a)&(b), but the welding method is not limited to this option alone and can be performed in accordance with other variations. Also, the welded members (first and second members) need not be rectangular as those shown in FIG. 5, and can have various shapes such as circular shapes, cylindrical shapes, semicircular shapes, or other regular or irregular shapes, according to their application. Also, these members may have the same or different thickness, or be formed having a step. The stepped portions of two members can be brought into contact with each other, such that they overlap and the contacting portions can be irradiated with laser light (such an embodiment is shown in the working example).

In the above description, scanning was performed by moving the laser irradiator 412, but the base 314 (shown in FIG. 3) may also be operated as an XYZ stage in accordance with the scanning pattern, for example.

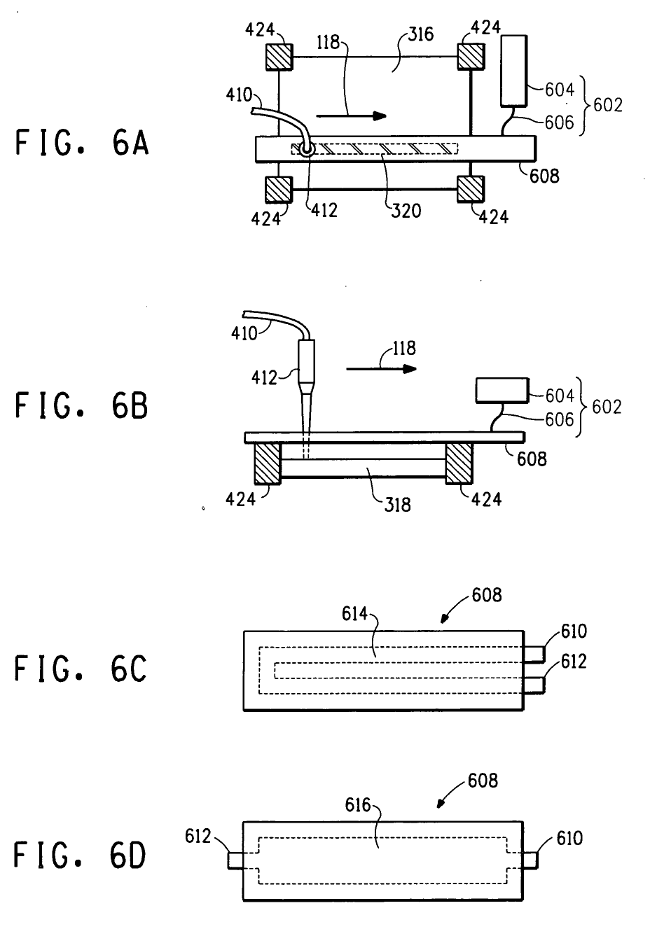

Reference is now made to FIG. 6, which shows a second embodiment of the present invention. In this embodiment covering and cooling means (b) is used wherein the protective region is a member that transmits laser light and covers the laser irradiator, and this member is cooled.

FIGS. 6(a) and (b) are schematic views illustrating a laser welding apparatus and a laser welding method that can be used in the present embodiment. The laser welding apparatus of the present embodiment shown in FIGS. 6(a) and (b) includes a covering member 608, a cooling means 602 for cooling the covering member, and other components that serve as the protective region formation means 306 (FIG. 4). The other structural elements are the same as in the embodiment previously described with reference to FIGS. 4 and 5, so their descriptions (configuration, operating conditions, and the like) are incorporated into the description of the present embodiment. FIG. 6 shows the laser irradiator 412, the optical fiber 410, the covering member 608, the cooling means 602, the first member 316, the second member 318, the fixing means 424 (for fixing the first and second members), the moving direction 118 thereof, laser light 114 (FIG. 2), and the welded portion 320.

With continuing reference to FIG. 6, the covering member covers the portion of the first member that is to be cooled, and is preferably a material that transmits laser light (such as glass, an acrylic resin, or the like). The material preferably has a high thermal conductivity. Preferred materials are crystalline substances that have a high transmissivity at the wavelength of the laser used for welding and high thermal conductivity. The covering member is held or fixed in place while kept in contact with the portion of the first member irradiated with laser light by with a clamp or air pressure, or other such appropriate holding method (not shown). The shape of the covering member is not particularly limited as long as the excess heat in the portion of the first member irradiated with laser light can be efficiently removed. Possible examples include a rectangular, circular, or other such plate-shaped member. The covering member 608 can also be provided with a mechanism for allowing a cooling medium or the like from the cooling means 602 to pass through. Specifically, for example, the covering member can be a plate-shaped member provided with a passage 614 having an inlet 610 and an outlet 612 for allowing the cooling medium to pass through the covering member as shown in FIG. 6(c), or the covering member can be a plate-shaped member having a hollow section 616 that has an inlet 610 and an outlet 612 as shown in FIG. 6(d).

The cooling means 602 may be any apparatus that can cool the covering member. An example is a cooling apparatus having a cooling device 604 that uses a cooling medium, and a feed line 606 for feeding the cooling medium to the covering member 608. In this case, the cooling medium is delivered to the feed line so that the covering member 608 can be efficiently cooled. For example, the feed line can be provided so as to circulate the medium around the covering member in the case of a liquid cooling medium or the feed line can be provided so that cold air or other gas can flow into or circulate around the entire covering member in the case of a gaseous cooling medium. For example, when a liquid or gaseous cooling medium is circulated, methods that can be adopted include those in which a tube for passing the cooling medium is placed in contact with the periphery of the covering member. When cold air is used, methods that can be adopted include the use of a tube having a plurality of cold air blowholes in the longitudinal direction of the covering member. Another possible option is to use a covering member which transmits laser light and which has a passage provided with an inlet and outlet, or to use a hollow covering member provided with an inlet and an outlet, and to use a cooling means whereby a cooling medium (gas or liquid) is flowed and circulated through the passage or the hollow portion in the direction from the inlet to the outlet, as shown in FIGS. 6(c) and (d). Another possible method is to use a configuration wherein the covering member that transmits laser light is cooled in advance as such, and the member is fixed in place while kept in contact with the portion of the first member irradiated with laser light. The cooling medium is a gas, liquid, or other fluid that is capable of conveying heat away from the surface of the first member.

Reference is now made to FIGS. 6(a) and (b) to describe an embodiment of the laser welding method of the present invention.

In the present embodiment, the first member 316 and second member 318 to be welded are fixed in place to the base 314 (not shown) by an appropriate fixing means 424. FIG. 6 shows an example wherein the four corners of the first and second members are fixed in place. Next, a protective region 304 is formed on the portion of the first member irradiated with laser light. In the present embodiment, the covering member of the covering and cooling means 306 is mounted in the protective region. The covering member is mounted by being fixed in place while kept in contact with the first member by an appropriate holder (means whereby the first and second members are fixed in place by the application of pressure on the junction between the first and second members with a clamp or air pressure, for example) (not shown). Examples suitable for use as covering member 608 are described above. The cooling means 602 is connected to the covering member 608. The covering member can be cooled by the various means described above. For example, a cooling medium may be fed to the covering member 608 from the cooling device 604 via the feed line 606. The cooling means is then operated to cool the covering member. During welding, the degree by which the surface temperature of the first member rises varies as a function of the laser welding conditions (such as the laser power, scanning speed, and the like) are adjusted, so he speed at which the cooling medium circulates should be adjusted to prevent the temperature of the protective region from rising. For example, an appropriate circulating speed should be set so that the surface temperature of the first member is about 100° C. or less, and preferably about 60° C. or less.

Next, the starting point of the portion in which the laser irradiator 412 is welded is set. The point may be set using the arm of an industrial robot (control means 312 shown in FIG. 3) that is provided with information about the scanning path and the like. Next, as the covering member is cooled, the laser irradiator 412 is scanned along the surface of the first member (along the direction of arrow 118, for example) using, for example, the arm of an industrial robot (not shown), for example, and laser welding is performed. The output, scanning speed, and other parameters of the laser are the same as described in the first embodiment.

In the present embodiment, the region with the covering member 608 serves as the protective region 304, and the portion of the first member 316 heated by laser light is cooled. The protective region is preferably formed while irradiation with laser light is carried out in order to ensure the function of the protective region in the present embodiment (the function of means (a)).

Linear welding is described in FIG. 6, but the welding method is not limited to this option alone and can be performed in accordance with a variety of patterns. Also, the welded members (first and second members) need not be rectangular as those shown in FIG. 6, and can have various shapes such as circular shapes, cylindrical shapes, semicircular shapes, or other regular or irregular shapes, according to their application. Also, these members may have the same or different thickness, or be formed having a step. The stepped portions of two members can be brought into contact with each other, such that they overlap and the contacting portions can be irradiated with laser light (such an embodiment is shown in the working example).

In the above description, scanning was performed by moving the laser irradiator 412, but the base 314 (FIG. 4(a)) may also be operated as an XYZ stage in accordance with the desired welding pattern, for example. Also, the first and second members and the covering member were held or fixed in place separately, but they may also be held or fixed in place using a single fixing means.

It is also noted that this embodiment of the present invention also has the functions of the fourth embodiment of the present invention hereinafter described.

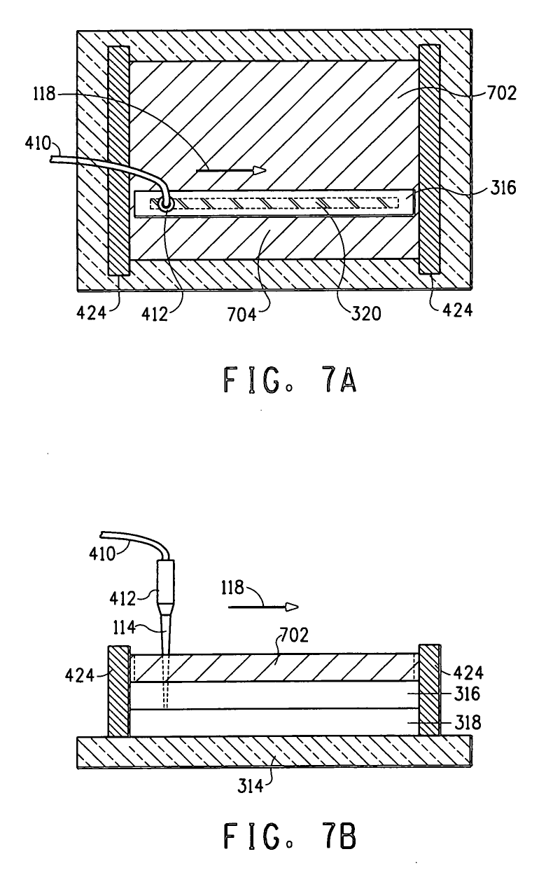

A third embodiment of the present invention is illustrated by reference to FIG. 7. This embodiment is an example corresponding to means (c) described above, wherein the protective region is provided by a heat dissipation means for dissipating excess heat by bonding a highly thermally conductive member onto the first member. In such a case, the heat dissipation means is designed such that a path is present to allow laser light to impinge directly on the surface of the first member without being blocked by the heat dissipation means.

FIGS. 7(a) and (b) are schematic views illustrating a laser welding apparatus and laser welding method that can be used in the present embodiment. The laser welding apparatus of the present embodiment shown in FIGS. 7(a) and (b) uses a covering member 702 as the protection means 306 (FIG. 4(a)). The other structural elements are the same as in the first embodiment of the present invention previously described with reference to FIGS. 4 and 5, so their descriptions (configuration, operating conditions, and the like) are incorporated in the description of the present embodiment. For simplicity and clarity, FIG. 7 shows only the laser irradiator 412, the optical fiber 410, the protection means (covering member 702), the base 314, the first member 316, the second member 318, the fixing means 424 (for fixing the first and second members and the covering member 702), the direction of motion 118 of the laser irradiator 412, laser light 114, and the welded portion 320.

With continuing reference to FIG. 7, the laser welding apparatus of this embodiment of the present invention provides a protection means 306 (FIG. 3) for preventing the overheating in the first member 316 due to irradiation with laser light. This protection means includes a covering member 702 for dispersing excess heat in the first member 316.

Continuing reference to FIG. 7, the covering member 702 is placed on the first member, is designed to cool the first member, and is preferably made of a highly thermally conductive material (for example, a metal such as iron, steel, or aluminum). The covering member is fixed in place while kept in contact with the first member by a fixing means for applying pressure to the junction between the covering member and the first member and holding the covering member in place with a clamp or air pressure, or other such appropriate fixing means. In the embodiment shown in FIG. 7, an example is shown wherein the fixing means 424 for holding or fixing in place both the first and second members is also used as the fixing means of the covering member. The first member 316, the second member 318, and the covering member 702 may be fixed so that the first and second members are fixed together and the covering member is fixed separately. A possible example of the fixing means is a device for applying pressure in the thickness direction and fixing the first and second members in place with a clamp or air pressure.

Referring to FIGS. 7(a) and (b), an embodiment of the laser welding method of the present invention will be described.

In the present embodiment, the first member 316 and second member 318 to be welded are placed on the base 314, and the covering member 702 having an opening 704 along the irradiation path of laser light is placed on the first member, as shown in FIG. 7(a). The covering member 702 may, for example, be made from a steel plate or another such material with good thermal conductivity. In the present embodiment, these members can be fixed in place by an appropriate fixing means (for example, by applying pressure to the junction between the covering member and the first member and holding the covering member in place with a clamp or air pressure). During fixing, the members are preferably held so that the covering member is firmly joined to the first member so as to allow thermal conduction to be effectively utilized.

Next, the laser irradiator 412 is placed at the starting point for welding. The irradiator is positioned using the arm of an industrial robot or other method known to those skilled in the art (control means 312, not shown), which is provided with information about the scanning path and the like. Next, the laser irradiator 412 is scanned along the welded portion 320 (for example, along the arrow 118) by the arm of the industrial robot (not shown), for example, and laser welding is performed. The output, scanning speed, and other parameters of the laser are the same as described in the first embodiment.

In the present embodiment, the region with the covering member 702 serves as the protective region 304, and the portion of the first member 316 heated by laser light is cooled by the thermal conduction of the covering member 702. The protective region is formed while irradiation with laser light is carried out.

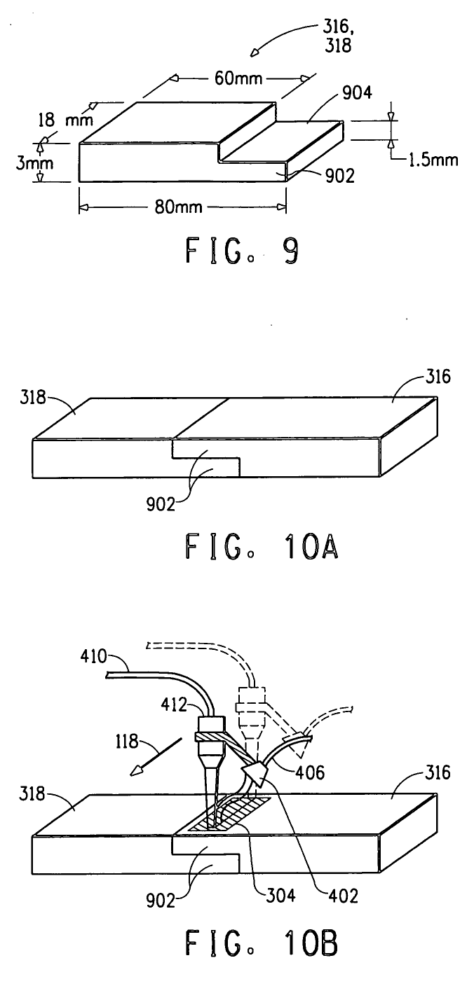

Linear welding is described in FIG. 7, but the welding method is not limited to this option alone and can be performed in accordance with a variety of patterns. Also, the welded members (first and second members) need not be rectangular as those shown in FIG. 7, and can have various shapes such as circular shapes, cylindrical shapes, semicircular shapes, or other regular or irregular shapes, according to their application. Also, these members may have the same or different thickness, or be formed having a step. The stepped portions of two members can be brought into contact with each other, such that they overlap and the contacting portions can be irradiated with laser light. An example of this embodiment is shown in FIGS. 9 and 10.

In the above description, scanning was performed by moving the laser irradiator 412, but the base 314 may also be operated as an XYZ stage in accordance with the desired welding pattern, for example.

The covering member of the present embodiment may be cooled as necessary (this case is also included in the third embodiment). The cooling apparatus described in the third embodiment can be used as the cooling means.

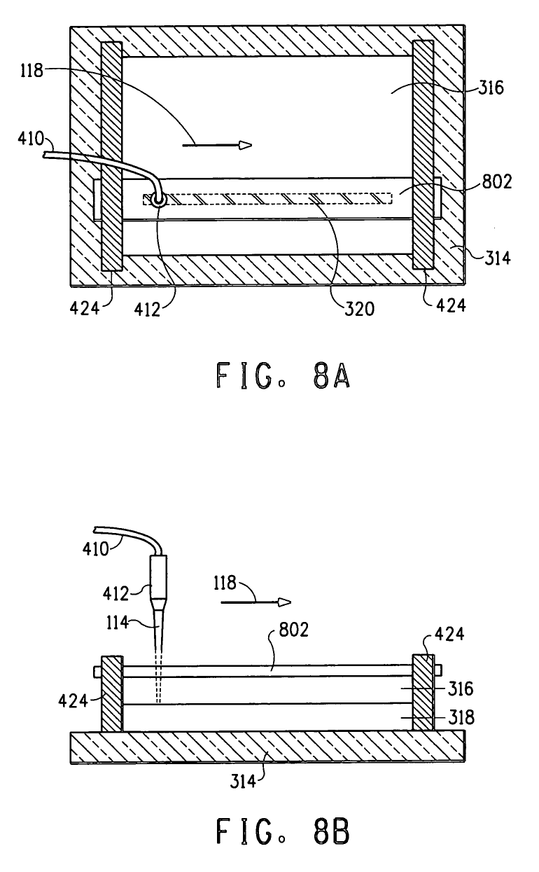

A fourth embodiment of the laser welding apparatus and laser welding method of the present invention is illustrated with reference to FIG. 8. In this embodiment of the present invention, the protective region is provided using a combustion prevention means (e). The portion of the surface of the first member irradiated with laser light or the area in the vicinity thereof is covered with a member that transmits laser light, keeping combustion-aiding substances such as oxygen from coming into contact with volatile substances released from the first member, preventing combustion of the volatile substances.

FIGS. 8(a) and (b) are schematic views describing a laser welding apparatus and laser welding method that can be used in an embodiment of the present invention. The laser welding apparatus of the present embodiment of the present invention shown in FIGS. 8(a) and (b) includes a blocking member 802 as the protective region formation means 306 (FIG. 4(a)). The other structural elements are the same as in the first embodiment previously described with reference to FIGS. 4 and 5, so their descriptions (configuration, operating conditions, and the like) are incorporated in the description of the present embodiment. For simplicity and clarity, FIG. 8 shows only the laser irradiator 412, the optical fiber 410, the blocking member 802 as the protection means (combustion prevention means), the fixing means 424 (for fixing the first and second members and the blocking member 802), the base 314, the first member 316, the direction of motion 118 of the laser irradiator, laser light 114, and the welded portion 320.

The laser welding apparatus of the present embodiment has a blocking member 802, which is a combustion prevention means having the functions described for means (e) above. The blocking member 802 prevents combustion-aiding substances such as oxygen from reaching volatile substances released from the first member 316 by the heat generated by irradiation with laser light. This blocking member covers the portion of the first member irradiated with laser light, and is preferably made of a material that transmits laser light (such as glass, an acrylic resin, or the like). The blocking member is fixed in place while being kept in contact with the portion of the first member irradiated with laser light by a fixing means for applying pressure to the junction between the blocking member and the first member and holding the covering member in place with a clamp or air pressure, or other such appropriate fixing means. In the embodiment shown in FIG. 8, the blocking member is fixed in place by the same fixing means 424 that is used to fix the first and second members in place.

The shape of the blocking member is not particularly limited as long as it can block combustion-aiding substances on the first member. It may be the rectangular flat plate-shaped member shown in FIG. 8, or it may be a circular plate-shaped member or have another regular or irregular shape. The blocking member is fixed in place on the first member so as to be firmly joined with the first member. The purpose of this arrangement is to efficiently prevent contact between the external combustion-aiding substances and volatile substances produced by irradiation with laser light between the first member and the blocking member. According to another method, the protective region can be formed with nitrogen, argon, helium, or another gas that does not aid combustion. In this case, the blocking member 802 is a gas, and the methods in the first embodiment of the present invention described above can be used unchanged to form the protective region with this gas.

Reference is now made to FIGS. 8(a) and (b) to describe an embodiment of the laser welding method of the present invention.

Referring now to FIG. 8(b), in the present embodiment, the first member 316 and second member 318 to be welded are placed on the base 314, and the blocking member 802 is mounted on the portion of the first member irradiated with laser light. These members are fixed in place by an appropriate fixing means (for example, means for applying pressure in the thickness direction and fixing the first and second members and the blocking member in place with a clamp or air pressure). The blocking member can be fixed in place while being kept in contact with the top of the first member by an appropriate fixing means.

Next, the laser irradiator 412 is placed at the starting point of the welded path. The irradiator is positioned using the arm of an industrial robot or other method known to those skilled in the art (for example, controller 312, FIG. 3), which is provided with information about the scanning path and the like. Next, the laser irradiator 412 is scanned along the welded portion 320 (for example, along the arrow 118) by the arm of the industrial robot (not shown), for example, and laser welding is performed. The output, scanning speed, and other parameters of the laser are the same as described in the first embodiment.

In the present embodiment, the region with the blocking member 802 serves as the protective region 304 (FIG. 3), and combustion-aiding substances are blocked from contacted volatiles released from member 316 when it is irradiated. The protective region is a gas, it is preferably continuously formed while irradiation with laser light is carried out in order to ensure the functions of the protective region in the present embodiment (the functions of means (e) described above, for example).

Linear welding was described in FIG. 8, but the welding method is not limited to this option alone and can be performed in accordance with a variety of patterns. Also, the welded members (first and second members) need not be rectangular as those shown in FIG. 8, and can have various shapes such as circular shapes, cylindrical shapes, semicircular shapes, or other regular or irregular shapes, according to their application. Also, these members may have the same or different thickness, or be formed having a step. The stepped portions of two members can be brought into contact with each other, such that they overlap and the contacting portions can be irradiated with laser light (such an embodiment is shown in the working example).

In the above description, scanning was performed by moving the laser irradiator 412, but the base 314 may also be operated as an XYZ stage in accordance with the scanning pattern, for example. The first and second members and the covering member were fixed in place with the same fixing means 424, but separate fixing device may also be used.

The embodiments described above are specific examples of the means (A) through (C) and (a) through (e), but a plurality of these means can also be provided as protective regions (protective means) to more effectively prevent the problems described in (i) through (iv) above. For example, the second embodiment has both the effects of cooling the first member and of removing combustion-aiding substances. Also, it is possible both to perform cooling and to remove volatile substances by combining the first and third embodiments. Another possibility is to further increase cooling efficiency by combining the cooling means in the second embodiment with the third embodiment. Yet another possibility is to form a protective region that has the effects of both cooling to dissipate excess heat and blocking combustion-aiding substances by combining the cooling means in the second embodiment with the fourth embodiment.

### EXAMPLES

In the following example the protective region is formed by means (a) and (e) by injecting air into the vicinity of portion the surface of the first member that is irradiated with laser light, but this example should not be construed as limiting the present invention.

### Examples 1-3 and Comparative Examples 1 and 2

In Examples 1-3 and Comparative Examples 1 and 2, the following polyester resin compositions were employed, and specimens produced from this composition were used to perform welding.

1) Poly(butylene terephthalate) A (PBT-A)

This resin composition is a glass fiber-reinforced poly(butylene terephthalate) resin composition prepared by melt blending 30 weight percent (based on the total weight of the composition) of glass fibers with poly(butylene terephthalate).

2) Polybutylene terephthalate B (PBT-B)

This resin composition is a glass fiber-reinforced poly(butylene terephthalate) resin composition prepared by melt blending 30 weight percent of glass fibers with 0.6 weight percent of carbon with poly(butylene terephthalate), wherein the weight percentages are based on the total weight of the composition.

Using these compositions, test bars having a half lap in the shape and dimensions of bar 902 as shown in FIG. 9 were molded at a resin temperature of 270° C. and a mold temperature of 80° C. using an injection molding machine. The test bars had a length of 80 mm, a width of 18 mm, and an overall thickness of 4 mm and a thickness of 2 mm in the half lap. The surfaces 904 of the half lap of two specimens were brought together and superimposed on each other to form a first member 316 and a second member 318 as shown in FIG. 10(a). The two members were fixed in place by applying air pressure. A diode laser (wavelength: 940 nm, focal point diameter: 3 mm, maximum output: 500 W) made by Rofin-Sinar (Germany) was used to perform welding. The welding was performed using an apparatus having the protective region formation means described in the first embodiment of the present invention, as shown in FIG. 10(b) and FIGS. 4 and 5 and described in the description of the first embodiment. The conditions used during laser welding (namely, the combinations of tests bars made from each of the two PBT resins that were used; the laser powers; the welding rate; and the presence or absence of a protective region (i.e. whether a gas injection apparatus for performing cooling and volatile gas removal was used)) are shown in Table 1. In the case of Examples 1-3 the gas injection apparatus was used. In the case of Comparative Examples 1 and 2, no protective means was used.

After laser welding, the resulting molded articles were observed with the naked eye to determine the conditions of surface defects (burning and/or baking) on the surface irradiated with laser light. Also, a tensile testing machine made by Shimadzu Corporation was used to measure the shear tensile strength of the welded molded articles at a tensile speed of 2 mm/min (referred to as “weld strength in the tables). The results are shown in Table 1. In Table 1, “NA” indicates that the surface appearance or laser weldability was not acceptable. “OK” indicates that the surface appearance or laser weldability were acceptable. This experiment was repeated three times as shown in Table 1.

### Examples 4-6

These examples illustrate that the method and apparatus of the present invention can be used even when the first member has a laser light transmissivity of greater than 25%. The resin compositions used and the specimens prepared therefrom were as follows.

1) Polyamide A

A glass fiber-reinforced resin composition prepared by 30 weight percent glass fibers (based on the total weight of the composition) with polyamide 6.

2) Polyamide B

A glass fiber-reinforced resin composition prepared by 30 weight percent glass fibers and 0.6 weight percent carbon black (where the weight percentages are based on the total weight of the composition) with polyamide 6.

Using these compositions, test bars having a half lap in the shape and dimensions of bar 902 as shown in FIG. 9 were molded at a resin temperature of 270° C. and a mold temperature of 80° C. using an injection molding machine. The test bars had a length of 80 mm, a width of 18 mm, and an overall thickness of 4 mm and a thickness of 2 mm in the half lap. The test bars were laser welding using the same procedure that was used for Examples 1-3 and Comparative Examples 1 and 2 and the conditions shown in Table 2. The results are shown in Table 2. As is clear from Table 2, welding was successful and the weld strength was sufficient.

Thus, the laser welding apparatus and welding method of the present invention can be successfully used even if the resin on the laser-irradiated side has a transmissivity greater than 25%.

It is therefore, apparent that there has been provided in accordance with the present invention, a laser welding apparatus and method that fully satisfies the aims and advantages hereinbefore set forth. While this invention has been described in conjunction with a specific embodiment thereof, it is evident that many alternatives, modifications, and variations will be apparent to those skilled in the art. Accordingly, it is intended to embrace all such alternatives, modifications and variations that fall within the spirit and broad scope of the appended claims.

TABLE 1

| | | Transmitting side | | Absorbing | | Laser | Scanning | | Weld | | |
|---|---|---|---|---|---|---|---|---|---|---|---|
| | | | Transmissivity | side | Protective | output | speed | Welding | strength | Weld- | Appear- |
| | No. | Material | (%) | material | region | (W) | (cm/min) | results | (kgf) | ability | ance |
| Example | 1 | PBT-A | 21 | PBT-B | yes | 100 | 100 | No surface | 168 | OK | OK |
| | | | | | | | | defects | | | |
| | | | | | | | | weldable | | | |
| | 2 | PBT-A | 21 | PBT-B | yes | 100 | 100 | No surface | 170 | OK | OK |
| | | | | | | | | defects | | | |
| | | | | | | | | weldable | | | |
| | 3 | PBT-A | 21 | PBT-B | yes | 100 | 100 | No surface | 166 | OK | OK |
| | | | | | | | | defects | | | |
| | | | | | | | | weldable | | | |
| Comparative | 1 | PBT-A | 21 | PBT-B | no | 100 | 100 | Spots form | 169 | OK | NA |
| Example | | | | | | | | burning on | | | |
| | | | | | | | | transmissive | | | |
| | | | | | | | | material | | | |
| | | | | | | | | surface (2 | | | |
| | | | | | | | | locations) | | | |
| | 2 | PBT-A | 21 | PBT-B | no | 100 | 100 | Transmissive | Cannot | NA | NA |
| | | | | | | | | material | be | | |
| | | | | | | | | surface burnt | measured | | |

TABLE 2

| | Transmitting side | | Absorbing | | Laser | Scanning | | Weld | | |
|---|---|---|---|---|---|---|---|---|---|---|
| | | Transmissivity | side | Protective | output | speed | Welding | strength | Weld- | Appear- |
| Example | Material | (%) | material | region | (W) | (cm/min) | results | (kgf) | ability | ance |
| 4 | Polyamide A | 57 | Polyamide B | Yes | 160 | 400 | No surface | 192 | OK | OK |
| | | | | | | | defects | | | |
| | | | | | | | weldable | | | |
| 5 | Polyamide A | 57 | Polyamide B | Yes | 180 | 400 | No surface | 206 | OK | OK |
| | | | | | | | defects | | | |
| | | | | | | | weldable | | | |
| 6 | Polyamide A | 57 | Polyamide B | Yes | 200 | 400 | No surface | 221 | OK | OK |
| | | | | | | | defects | | | |
| | | | | | | | weldable | | | |

What is claimed is:

1. A laser welding apparatus wherein a first member comprising a thermoplastic polymer and a second member comprising a thermoplastic polymer are brought into contact with each other, and the first and second members are welded together by irradiation of a surface of the first member with laser light, such that the laser light passes through the first member and contacts the second member, and wherein the second member is capable of absorbing the laser light at the point at which the laser light contacts the second member, said laser welding apparatus characterized in that it comprises:
laser light irradiation means;
fixing means for holding or fixing in place the first and second members; and
means for forming a protective region on the first member.

2. The apparatus of claim 1, wherein the first member has a laser light transmissivity of about 25 percent or less at the wavelength of the laser light.

3. The apparatus of claim 1, wherein the means for forming a protective region is a means for cooling the surface of the first member where it is irradiated with laser light.

4. The apparatus of claim 1, wherein the means for forming a protective region is a means for removing volatile substances emitted from the surface of the first member where it is irradiated with laser light.

5. The apparatus of claim 1, wherein the means for forming a protective region is a means for blocking substances that aid combustion from the surface of the first member where it is irradiated with laser light.

6. The apparatus of claim 3, wherein the means for cooling the surface of the first member where it is irradiated with laser light comprises an injection means for injecting a gas at a temperature of about 0 to about 50° C. onto the surface of the first member where it is irradiated with laser light.

7. The apparatus of claim 3, wherein the means for cooling the surface of the first member where it is irradiated with laser light comprises a covering and cooling means for covering the surface of the first member where it is irradiated with laser light with a cooled member that transmits laser light.

8. The apparatus of claim 3, wherein the means for cooling the surface of the first member where it is irradiated with laser light comprises a heat dissipation means that is joined to the first member at a point other than the portion of the surface where it is irradiated with laser light and that dissipates heat from the surface of the first member where it is irradiated with laser light.

9. The apparatus of claim 4, wherein the means for removing volatile substances formed on the surface of the first member where it is irradiated with laser light comprises an injection means for injecting a gas onto the surface of the first member where it is irradiated with laser light or into the vicinity of the surface.

10. The apparatus of claim 1, wherein the thermoplastic polymer is polyester, liquid crystalline polyester, or poly(phenylene sufide).

11. The apparatus of claim 10, wherein the polyester is one or more of poly(ethylene terephthalate), poly(butylene terephthalate), and poly(propylene terephthalate).

12. A method of laser welding two members, wherein a first member comprising a thermoplastic polymer is brought into contact with a second member comprising a thermoplastic polymer and the first and second members are welded together by irradiation of a surface of the first member with laser light, such that the laser light passes through the first member and contacts the second member, and wherein the second member is capable of absorbing the laser light at the point at which the laser light contacts the second member, and wherein a protective region is formed on the first member while the surface of the first member is irradiated by the laser light.

13. The method of claim 12 wherein the first member has a laser light transmissivity of about 25 percent or less at the wavelength of the laser light.

14. The method of claim 12, wherein the protective region is formed by cooling the surface of the first member where it is irradiated with the laser light using a cooling means.

15. The method of claim 12, wherein the protective region is formed by using a means for removing volatile substances emitted from the surface of the first member.

16. The method of claim 12, wherein the protective region is formed by using a blocking means that blocks combustion-aiding substance from the surface of the first member irradiated with the laser light.

17. The method of claim 14, wherein the cooling means comprises an injection means for injecting a gas at a temperature of about 0 to about 50° C. onto the surface of the first member where it is irradiated with laser light

18. The method of claim 14, wherein the cooling means comprises a covering and cooling means for covering the surface of the first member where it is irradiated with laser light with a cooled member that transmits laser light.

19. The method of claim 14, wherein the cooling means comprises a heat dissipation means that is joined to the first member at a point other than the portion of the surface where it is irradiated with laser light and that dissipates heat from the surface of the first member where it is irradiated with laser light.

20. The method of claim 15, wherein the means for removing volatile substances comprises an injection means for injecting a gas onto the surface of the first member where it is irradiated with laser light or into the vicinity of the surface.
